(19) United States
(12) Patent Application Publication
(10) Pub. No.: US 2005/0172127 A1
(43) Pub. Date: Aug. 4, 2005

(54) System and method for transcoding encrypted multimedia messages transmitted between two devices

(76) Inventors: Frank Hartung, Herzogenrath (DE); Goran Selander, Stockholm (SE)

Correspondence Address: ERICSSON INC., 6300 LEGACY DRIVE, M/S EVR C11, PLANO, TX, 75024, US

(21) Appl. No.: 10/769,566

(22) Filed: Jan. 31, 2004

(51) Int. Cl. H04L 9/00

(52) U.S. Cl. 713/167

(57) ABSTRACT

A system, method and transcoding proxy are described herein that are capable of transcoding encrypted content, like an encrypted multimedia message or a multimedia message containing encrypted elements parts, which is transmitted between two devices (e.g., mobile phones). Basically, the transcoding proxy receives an encrypted multimedia message from a first device (e.g., mobile phone). The transcoding proxy then requests and receives a transcoding rights object (TRO) message from a rights issuer which includes a content encryption key (CEK) and a transcoding permission message (optional). After receiving the TRO message, the transcoding proxy is able to (1) decrypt the encrypted multimedia message (2) transcode the decrypted multimedia message so it matches the capabilities of a second device and could be accessed by a user of the second device (e.g., mobile phone) and (3) re-encrypt the transcoded multimedia message. The transcoding proxy then sends the re-encrypted transcoded multimedia message to the second device.

### BACKGROUND OF THE INVENTION

1. Field of the Invention

The present invention relates in general to the wireless communications field and, in particular, to a system and method for transcoding encrypted content, like an encrypted multimedia message or parts thereof, that is sent from one device (e.g., mobile phone) and received at a second device (e.g., mobile phone).

2. Description of Related Art

Multimedia Messaging Service (MMS) is a service commonly used in GSM and WCDMA/UMTS networks which makes it possible for mobile users to send and receive multimedia messages (e.g., text, image, audio and/or video messages). Today when a multimedia message is sent to a device (e.g., mobile phone) then the multimedia message needs to be adapted for the device so the user of that device can access the multimedia message. This adaptation requirement is not a problem when a multimedia message is sent from a server to a device because the multimedia message is usually generated by the server in accordance with the capabilities of the device (as signaled in UAProf etc.). However, the adaptation requirement becomes more difficult in the situation when a multimedia message is sent from one device (e.g., mobile phone) to another device (e.g., mobile phone) where both devices have different capabilities such as codecs, available memory, display size etc. . . . when it comes to supporting multimedia messages.

Fortunately, the adaptation requirement is not a problem when a non-encrypted multimedia message is transmitted from one device to another device. This scenario is shown in FIG. 1 (PRIOR ART), where the user of the first device 102 interacts through the Internet/mobile network 104 to browse and select content (step 1) from a content provider 106. This step may be omitted if the encrypted content is sent to the user of the first device 102 as a push service or subscription service. The content provider 106 sends the non-encrypted content (step 2) to the first device 102. The user of the first device 102 can now access the content (multimedia message) and forward the content to a second device 108. To forward the content to the second device 108, the first device 102 sends the non-encrypted content (step 3) through a mobile network 110 to a transcoding proxy 112 (e.g., Multimedia Messaging Service Center (MMS-C) 112). The transcoding proxy 112 transcodes the non-encrypted content (step 4), if necessary, and sends the non-encrypted transcoded content (step 5) through the mobile network 110 to the second device 108. The user of the second device 108 can now access the content (multimedia message).

It should be appreciated that before the transcoding proxy 112 can transcode the content (step 4) it needs to have information about the properties/capabilities of the second device 108 so it can properly transcode the multimedia message in a manner that the transcoded multimedia message can be accessed by the user of the second device 108. To inform the transcoding proxy 112 about the properties/capabilities of the second device 108, the second device 108 can send the properties/capabilities information to the transcoding proxy 112 in HyperText Transport Protocol (HTTP) accepts headers or UAProf (for example). Or, the transcoding proxy 112 can obtain the properties/capabilities of the second device 108 from a network node such as a Mobile Switching Center (MSC)/Home Location Register (HLR)(for example).

Unfortunately, the adaptation requirement is currently a problem when encrypted content, like an encrypted multimedia message or a multimedia message containing encrypted elements, is transmitted from one device to another device. This scenario is shown in FIG. 2 (PRIOR ART), where the user of the first device 202 interacts through the Internet/mobile network 204 to browse and select content (step 1) from a content provider 206. This step may be omitted if the encrypted content is sent to the user of the first device 202 as a push service or subscription service. The content provider 206 sends the encrypted content (step 2) to the first device 202. For instance, the content can be encrypted with a content encryption key (CEK) in accordance with the Open Mobile Alliance's (OMA) standard known as Digital Rights Management 2.0 (DRM 2.0). If OMA DRM 2.0 is used, then the first device 202 sends a rights object (RO) request (step 3) through the Internet/mobile network 204 to a rights issuer 208. The rights issuer 208 then sends a RO message (step 4) that contains the CEK in addition to various usage permissions and restrictions to the first device 202. The RO message itself or parts of it can also be encrypted with a public key of the first device 202. As such the RO message can only be decrypted with a private key of the first device 202 which is securely stored in the first device 202. In this way, the RO message and CEK can only be accessed by the first device 202. Alternatively, the RO message can also be encrypted with a domain key that has previously been sent to the first device 202, while being encrypted with a public key of the first device 202. In this case, the RO message can only be decrypted with the domain key which can only be decrypted by a private key of the first device 202 which is securely stored in the first device 202. At this point, the user of the first device 202 can access the encrypted content (multimedia message) but would have a problem as described in detail below if they tried to forward the encrypted content to a second device 210.

If the user of the first device 202 tried to forward the encrypted content to the second device 210, the first device 202 would forward the encrypted content (step 5) through a mobile network 212 which is then intercepted by a transcoding proxy 214 (e.g., MMS-C 214). Since the content is encrypted, the transcoding proxy cannot decrypt and transcode the content which is problematical. This problem would not be solved if the first device 202 forwarded the RO message to the transcoding proxy 214, because the RO message can only be decrypted by the first device 202. Thus, the only choice for the transcoding proxy 214 is to forward the non-transcoded encrypted content (step 6) to second device 210. The second device 210 can then use the Uniform Resource Locator (URL) in the content object that is associated with the rights issuer 208 to request a RO message (step 7) from the rights issuer 208. The rights issuer 208 would then send the RO message (step 8) that contains the CEK to the second device 210. However, the user of the second device 210 even with the CEK will most likely not be able to access the content because the content is not likely to be in a format (e.g., codec, display size) that is supported by the second device 208. Accordingly, there is a need for a way to adapt (transcode) an encrypted multimedia message that is transmitted from a first device to a second device so the user of the second device can successfully access the multimedia message. This need is satisfied by the transcoding proxy, system and method of the present invention.

### BRIEF DESCRIPTION OF THE INVENTION

The present invention includes a system, method and transcoding proxy capable of transcoding encrypted content, in particular an encrypted multimedia message or a multimedia message containing encrypted elements, that is transmitted between two devices (e.g., mobile phones). Basically, the transcoding proxy receives an encrypted multimedia message from a first device (e.g., mobile phone). The transcoding proxy then requests and receives a transcoding rights object (TRO) message from a rights issuer which includes a content encryption key (CEK) and a transcoding permission message (optional). After receiving the TRO message, the transcoding proxy is able to (1) decrypt the encrypted multimedia message (2) transcode the decrypted multimedia message so it matches the capabilities of a second device and it could be accessed by a user of the second device (e.g., mobile phone) and (3) re-encrypt the transcoded multimedia message. The transcoding proxy then sends the re-encrypted transcoded multimedia message to the second device.

### BRIEF DESCRIPTION OF THE DRAWINGS

A more complete understanding of the present invention may be obtained by reference to the following detailed description when taken in conjunction with the accompanying drawings wherein:

FIG. 1 (PRIOR ART) is a block diagram/signal chart illustrating how a first device is able to successfully transmit a non-encrypted multimedia message to a second device;

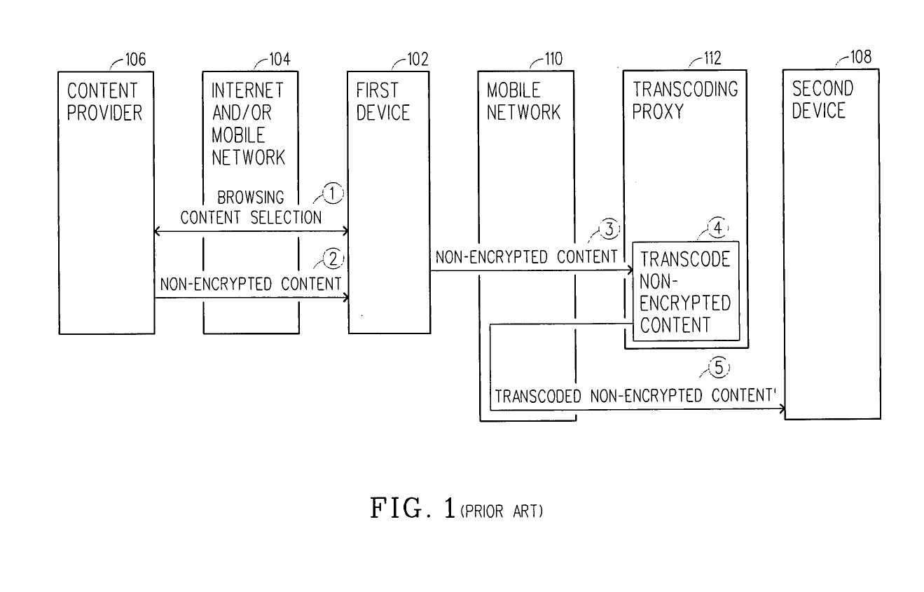

FIG. 2 (PRIOR ART) is a block diagram/signal chart illustrating how a first device can have problems trying to transmit an encrypted multimedia message to a second device; and

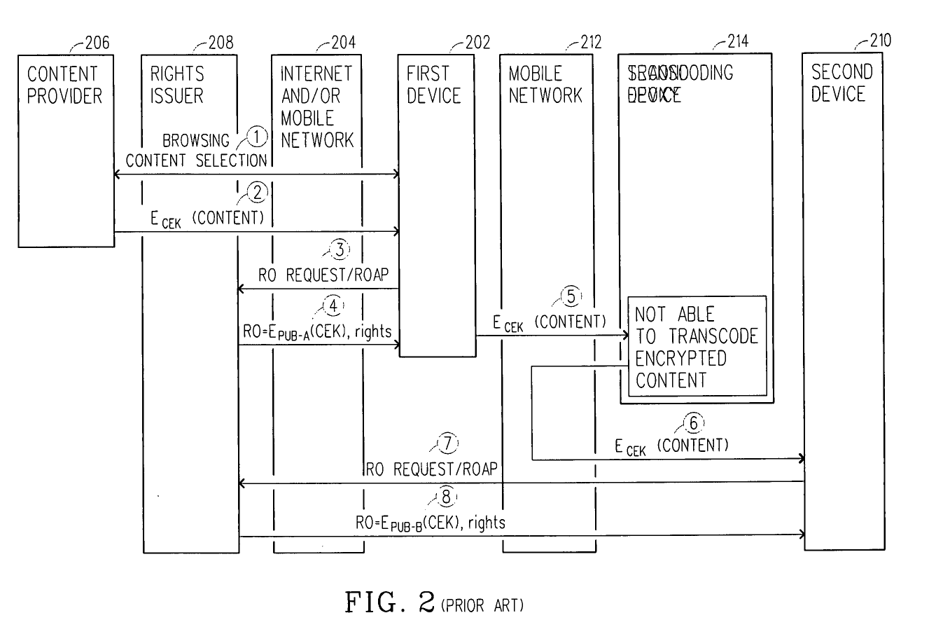

FIG. 3 is a block diagram/signal chart illustrating how a first device is able to successfully transmit an encrypted multimedia message to a second device in accordance with the present invention.

### DETAILED DESCRIPTION OF THE DRAWINGS

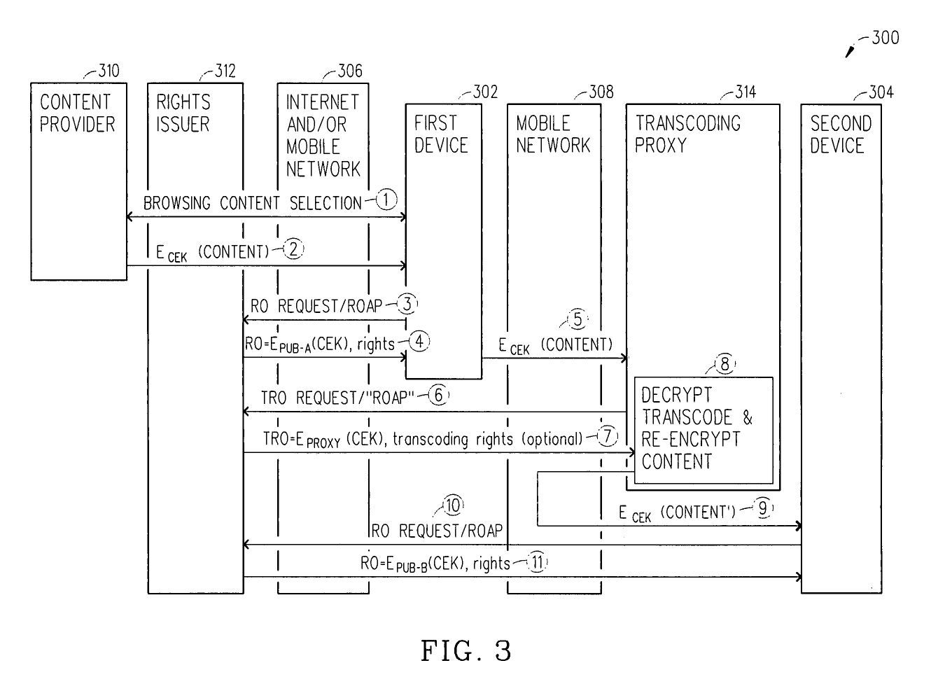

Referring to FIG. 3, there is shown a preferred embodiment of a system/method 300 capable of transcoding (adapting) an encrypted multimedia message that is transmitted between two devices 302 and 304 (e.g., mobile phones 302 and 304) in accordance with the present invention. It should be appreciated that certain details associated with the components within the system 300 like the Internet 306 and the mobile network 308 are well known in the industry. Therefore, for clarity, the description provided omits those well known components and other details that are not necessary to understand the present invention.

As shown in FIG. 3, the user of the first device 302 interacts through the Internet/mobile network 306 to browse and select content (step 1) from a content provider 310. This step may be omitted if the encrypted content is sent to the user of the first device 302 as a push service or subscription service. The content is for example a multimedia message such as text, image, audio and/or video, where some or all of the media elements are encrypted. The content provider 310 sends the encrypted content (step 2) to the first device 302. The content can be encrypted with a content encryption key (CEK) pursuant to the OMA DRM 2.0 (for example). The first device 302 then sends a rights object (RO) request (step 3) through the Internet 306 to a rights issuer 312. This step may be omitted if the first device 302 has previously been registered with the rights issuer 312 and the rights issuer 312 pushes rights objects to the first device 302. The rights issuer 312 then sends a RO message (step 4) that contains the CEK in addition to various usage permissions and restrictions to the first device 302. The RO message itself or parts of it can also be encrypted with a public key of the first device 302. If this is the case then the RO message can only be decrypted with a private key of the first device 302 which is securely stored in the first device 302. In this way, relevant information in the RO message and CEK can only be accessed by the first device 302. Alternatively, the RO message can also be encrypted with a domain key that has previously been sent to the first device, while being encrypted with a public key of the first device. In this case, the RO message can only be decrypted with the domain key which can only be decrypted by a private key of the first device 302 which is securely stored in the first device 302. At this point, the user of the first device 302 can access the encrypted content (multimedia message).

The user of the first device 302 can now in accordance with the present invention successfully forward the encrypted content to the second device 304. To accomplish this, the first device 302 would forward the encrypted content (step 5) through the mobile network 308 which is then intercepted by a transcoding proxy 314 (e.g., MMS-C 314). Since the content is encrypted, the transcoding proxy 314 uses the rights issuer URL in the encrypted content elements to send a request (in the event there are multiple protected elements in the message then multiple requests may be needed as described in greater detail below) for a transcoding rights object (TRO) message (step 6) to the rights issuer 312. The rights issuer 312 then sends the TRO message (step 7)(in the event there are multiple protected elements in the message then multiple TRO messages may be needed as described in greater detail below) to the transcoding proxy 314. The TRO message includes a CEK and transcoding permissions (optional) that can be configured as follows:
The CEK can be: (1) in cleartext (i.e., CEK sent as CEK); (2) encrypted with a shared secret between the rights issuer 312 and transcoding proxy 314 that could be established out of band (i.e., CEK sent as E_{PROXY}_{_{—}}_{SHARED}(CEK)); (3) encrypted with a public key of the transcoding proxy 314 (i.e., CEK sent as E_{PROXY}_{_{—}}_{PUBLIC}(CEK)) wherein the public key could be sent from the transcoding proxy 314 to the rights issuer 312, or be stored at the rights issuer 312, or be retrieved from another place; (4) encrypted with a domain key that has previously been sent from the rights issuer 312 to the transcoding proxy 314. As an alternative, the transcoding proxy 314 could be an OMA DRM compliant entity, thus the transcoding RO request (step 6) could be identical to a RO request of a device—an execution of the Rights Object Acquisition Protocol (ROAP) protocol, the central protocol suite of OMA DRM 2.0. The trancoding RO could be identical to an OMA DRM RO.
The transcoding permission message can be omitted if the transcoding proxy 314 has “implicit” permission to transcode the encrypted multimedia message whenever it receives the TRO message and the CEK. Alternatively, the transcoding permission message can be “explicitly” expressed by using a Rights Expression Language (REL), or by using a REL extension, or by using another machine readable signaling. The transcoding permission message could specify which transcodings (between which codes formats etc.) can be performed by the transcoding proxy 314. In addition, the transcoding permission message could specify whether the transcoding proxy 314 is allowed to perform consecutive transcodings, i.e. transcoding of content that has previously been transcoded.

It should be appreciated that the transcoding proxy 314 can use the URL in the content object (possibly appended by a postfix/appendix) that is associated with the rights issuer 312 to request the TRO message (step 6) from the rights issuer 312. For example, if the URL of the rights issuer 312 stored in the content object is http://rightsserver.com then the request for the TRO message could be an HTTP GET to http://rightsserver.com/send-me-a-TRO. Then the rights issuer 312 could authenticate/authorize the transcoding proxy 314 out of band, possibly request a public key out of band, generate the TRO message, and send the TRO message (step 7) to the transcoding proxy 314. The TRO message can be sent unprotected or over a secure tunnel (e.g. IPSec tunnel). The use of a secure tunnel would be advised if the TRO message contained the CEK in the unprotected cleartext form. However, the secure tunnel may not be necessary if all communications are within a trusted network, e.g. operator Intranet.

After the transcoding proxy 314 receives the TRO message (step 7), the transcoding proxy 314 then uses the CEK and the transcoding permission message (optional) to (1) decrypt the encrypted multimedia message (2) transcode the decrypted multimedia message so it matches the capabilities of the second device 304 and (3) re-encrypt the transcoded multimedia message (step 8). It should be appreciated that before the transcoding proxy 314 can transcode the content (step 8) it needs to have information about the properties/capabilities of the second device 304 so it can properly transcode the multimedia message (step 8) in a manner that the transcoded multimedia message can be accessed by the user of the second device 304. To inform the transcoding proxy 314 about the properties/capabilities of the second device 304, the second device 304 can send the properties/capabilities information to the transcoding proxy 314 in HTTP accepts headers or UAProf (for example). Or, the transcoding proxy 314 can obtain the properties/capabilities of the second device 304 from a network node such as a MSC/HLR (for example).

After the transcoding proxy 314 transcodes the content (step 8) it then sends the re-encrypted transcoded content (step 9) through the mobile network 308 to the second device 304. The second device 304 can then use the URL in the content object (possibly appended by a postfix/appendix) associated with the rights issuer 312 to request a RO message (step 10) from the rights issuer 312. The rights issuer 312 would then send the RO message (step 11) that contains the CEK to the second device 304. The user of the second device 304 can now access the content (multimedia message). It should be appreciated that the flows shown in FIG. 3 can be varied in many ways and that they have been simplified and targeted specifically for the OMA DRM 2.0 standard.

In the preferred embodiment, the transcoding proxy 314 is assumed to be a trusted entity. This assumption is realistic since the transcoding proxy 314 is generally located in a controlled environment. For example, the transcoding proxy 314 can be a MMC-S or a Multimedia Processor (MMP) which is located in an operator network. Moreover, the rights issuer 312 is assumed to be able to authenticate and authorize the transcoding proxy 314 by using mechanisms like a licensing trust model, public key certificates, shared secret keys, cryptographic assertions or tokens (for example). This assumption is realistic, especially in the case where the rights issuer 312 is also in the operator network.

From the foregoing, it can be readily appreciated by those skilled in the art that the present invention provides a system/method for enabling a user of a first device (e.g., mobile phone) to transmit an encrypted multimedia message to a second device (e.g., mobile phone) that can be accessed by the user of the second device. Essentially, the present invention uses a special procedure/protocol and a special TRO message to enable a transcoding proxy to transcode (adapt) the encrypted multimedia message received from a first device (e.g., mobile phone) so that it can be successfully accessed by the user of a second device (e.g., mobile phone). In particular, the transcoding proxy receives an encrypted multimedia message from a first device (e.g., mobile phone). The transcoding proxy then requests and receives a transcoding rights object (TRO) message from a rights issuer which includes a content encryption key (CEK) and a transcoding permission message (optional). After receiving the TRO message, the transcoding proxy is able to (1) decrypt the encrypted multimedia message (2) transcode the decrypted multimedia message so it could be accessed by a user of a second device (e.g., mobile phone) and (3) re-encrypt the transcoded multimedia message. The transcoding proxy then sends the re-encrypted transcoded multimedia message to the second device.

Following are some additional features, advantages and uses of the transcoding proxy 314 and the system/method 300 of the present invention:
The present invention enhances the OMA DRM 2.0 standard such that transcoding of protected/encrypted content is now possible on trusted nodes. The contents of OMA DRM 2.0 are hereby incorporated by reference herein.
The present invention can also be used to enhance the separate delivery mode of the OMA DRM 1.0 standard such that the transcoding of protected/encrypted content is now possible on trusted nodes. The contents of OMA DRM 1.0 are hereby incorporated by reference herein.
It should be understood that the interface between the transcoding proxy 314 and the rights issuer 312 can be a standardized interface or a proprietary, non-standardized interface. A possible standardized interface is to re-use ROAP which is supported by all OMA DRM rights issuers.
It should also be appreciated that if the MMS message contains multiple protected elements then there are multiple ROs involved and the transcoding proxy 314 in addition to the first and second devices may have to request multiple ROs/TROs.
As described above, the multimedia messages can be transcoded in the MMS-C (Multimedia Messaging Service Center). In Ericsson's products, the present invention may be implemented in the MMP (multimedia processor) which interfaces a Multimedia Messaging Center (MMC).
It should also be appreciated that the transcoder proxy may contain an OMA DRM compliant/licensed entity trusted by the rights issuer in which all content sensitive operations are performed. The presence of such an entity would reduce the need for additional trust assumptions on the transcoding proxy beyond those of any DRM compliant device.

Although one embodiment of the present invention has been illustrated in the accompanying Drawings and described in the foregoing Detailed Description, it should be understood that the invention is not limited to the embodiment disclosed, but is capable of numerous rearrangements, modifications and substitutions without departing from the spirit of the invention as set forth and defined by the following claims.

1. A transcoding proxy capable of transcoding encrypted content, like an encrypted multimedia message or a multimedia message containing encrypted elements parts, transmitted between two devices by performing the following steps:
receiving an encrypted multimedia message from a first device;
requesting and receiving a message which enables the performance of the following steps:
decrypting the encrypted multimedia message;
transcoding the decrypted multimedia message so the multimedia message matches the capabilities of second device and can be accessed by a user of said second device; and
re-encrypting the transcoded multimedia message; and
sending the re-encrypted transcoded multimedia message to the second device.

2. The transcoding proxy of claim 1, wherein said message is a transcoding rights object (TRO) message that includes at least a content encryption key (CEK), and optional permissions for transcoding the multimedia message.

3. The transcoding proxy of claim 2, wherein said CEK is an encrypted CEK.

4. The transcoding proxy of claim 2, wherein said permission for transcoding the multimedia message is implicit with the provisioning of the CEK.

5. The transcoding proxy of claim 1, wherein:
said first device is a mobile phone; and
said second device is a mobile phone.

6. The transcoding proxy of claim 1, wherein said multimedia message is one or any combination of text, image, audio or video.

7. The transcoding proxy of claim 1, wherein said transcoding proxy is a Multimedia Messaging Service Center (MMS-C).

8. The transcoding proxy of claim 1, wherein said transcoding proxy contains an OMA DRM compliant/licensed entity trusted by a rights issuer.

9. The transcoding proxy of claim 1, wherein said encrypted multimedia message includes a multimedia message containing encrypted elements parts.

10. The transcoding proxy of claim 1, wherein said transcoding proxy is an Open Mobile Alliance's (OMA) Digital Rights Management (DRM) compliant entity and said message is a rights object (RO) message.

11. A method for transcoding encrypted multimedia messages transmitted between two devices, said method comprising the steps of:
receiving an encrypted multimedia message from a first device;
requesting and receiving a message which enables the following steps:
decrypting the encrypted multimedia message;
transcoding the decrypted multimedia message so the multimedia message could be accessed by a user of a second device;
re-encrypting the transcoded multimedia message; and
sending the re-encrypted transcoded multimedia message to the second device.

12. The method of claim 11, wherein said message is a transcoding rights object (TRO) message that includes at least a content encryption key (CEK), and optional permissions for transcoding the multimedia message.

13. The method of claim 12, wherein said CEK is an encrypted CEK.

14. The method of claim 12, wherein said permission for transcoding the multimedia message is implicit with the provisioning of the CEK.

15. The method of claim 11, wherein:
said first device is a mobile phone; and
said second device is a mobile phone.

16. The method of claim 11, wherein said multimedia message is one or any combination of text, image, audio or video.

17. The method of claim 11, wherein said message is a rights object (RO) message.

18. The method of claim 11, wherein said encrypted multimedia message includes a multimedia message containing encrypted elements parts.

19. A system for providing a Multimedia Messaging Service (MMS), said system comprising:
a content provider for providing an encrypted multimedia message to a first device;
a rights issuer for providing a content encryption key (CEK) to said first device so that a user said first device can access the encrypted multimedia message;
a transcoding proxy for receiving the encrypted multimedia message from said first device;
said transcoding proxy for requesting and receiving a transcoding rights object (TRO) message from said rights issuer;
said transcoding proxy for using the TRO message to perform the following steps:
decrypting the encrypted multimedia message;
transcoding the decrypted multimedia message so the multimedia message could be accessed by a user of a second device; and
re-encrypting the transcoded multimedia message;
said transcoding proxy for sending the re-encrypted transcoded multimedia message to the second device; and
said rights issuer for providing a content encryption key (CEK) to said second device so that the user of said second device can access the re-encrypted transcoded multimedia message.

20. The system of claim 19, wherein said transcoding proxy is a trusted entity.

21. The system of claim 19, wherein said rights issuer can authenticate and authorize said transcoding proxy.

22. The system of claim 19, wherein said TRO message includes a content encryption key (CEK) and permission for transcoding the multimedia message.

23. The system of claim 22, wherein said CEK is encrypted with a shared secret between said rights issuer and said transcoding proxy.

24. The system of claim 22, wherein said CEK is encrypted with a public key associated with said transcoding proxy.

25. The system of claim 22, wherein said permission for transcoding the multimedia message is implicit with the provisioning of the CEK.

26. The system of claim 22, wherein said permission for transcoding the multimedia message is expressed by using a Rights Expression Language or a Rights Expression Language Extension or another machine readable signaling.

27. The system of claim 22, wherein said transcoding permission message specifies which transcoding is permitted and whether consecutive transcoding is allowed in said transcoding proxy.

28. The system of claim 19, wherein said transcoding proxy uses an Uniform Resource Locator (URL) of said rights issuer to request the TRO message from said rights issuer.

29. The system of claim 19, wherein said TRO message is sent from said rights issuer to said transcoding proxy over an unprotected channel.

30. The system of claim 19, wherein said TRO message is sent from said rights issuer to said transcoding proxy over a secured channel.

31. The system of claim 19, wherein:
said first device is a mobile phone; and
said second device is a mobile phone.

32. The system of claim 19, wherein said multimedia message is one or any combination of text, image, audio or video.

33. A method for transcoding encrypted multimedia messages transmitted between two devices, said method comprising the steps of:
providing an encrypted multimedia message from a content provider to a first device;
providing a content encryption key (CEK) from a rights issuer to said first device so that a user of said first device can access the encrypted multimedia message;
receiving, at a transcoding proxy, the encrypted multimedia message from said first device;
receiving, at the transcoding proxy, a transcoding rights object (TRO) message that was requested from said rights issuer, wherein said transcoding proxy uses the TRO message to perform the following steps:
decrypting the encrypted multimedia message;
transcoding the decrypted multimedia message so the multimedia message could be accessed by a user of a second device; and
re-encrypting the transcoded multimedia message;
sending the re-encrypted transcoded multimedia message from said transcoding proxy to the second device; and
providing a content encryption key (CEK) from said rights issuer to said second device so that the user of said second device can access the re-encrypted transcoded multimedia message.

34. The method of claim 33, wherein said transcoding proxy is a trusted entity.

35. The method of claim 33, wherein said rights issuer can authenticate and authorize said transcoding proxy.

36. The method of claim 33, wherein said TRO message includes a content encryption key (CEK) and permission for transcoding the multimedia message.

37. The method of claim 36, wherein said CEK is encrypted with a shared secret between said rights issuer and said transcoding proxy.

38. The method of claim 36, wherein said CEK is encrypted with a public key associated with said transcoding proxy.

39. The method of claim 36, wherein said permission for transcoding the multimedia message is implicit with the provisioning of the CEK.

40. The method of claim 36, wherein said permission for transcoding the multimedia message is expressed by using a Rights Expression Language or a Rights Expression Language Extension or another machine readable signaling.

41. The method of claim 36, wherein said permission for transcoding the multimedia message specifies which transcoding is permitted by said transcoding proxy and whether consecutive transcoding is allowed in said transcoding proxy.

42. The method of claim 33, wherein said transcoding proxy uses an Uniform Resource Locator (URL) of said rights issuer to request the TRO message from said rights issuer.

43. The method of claim 33, wherein said TRO message is sent from said rights issuer to said transcoding proxy over an unprotected channel.

44. The method of claim 33, wherein said TRO message is sent from said rights issuer to said transcoding proxy over a secured channel.

45. The method of claim 33, wherein:
said first device is a mobile phone; and
said second device is a mobile phone.

46. The method of claim 33, wherein said multimedia message is one or any combination of text, image, audio or video.

47. A device capable of sending an encrypted multimedia message to a transcoding proxy which requests and receives a message that enables the transcoding proxy to decrypt the encrypted multimedia message, transcode the decrypted multimedia message and re-encrypt the transcoded multimedia message before forwarding the re-encrypted transcoded multimedia message to another device.

48. The device of claim 47, wherein said message is a transcoding rights object (TRO) message that includes a content encryption key (CEK) and permission for transcoding the multimedia message.

49. A device capable of receiving and playing a re-encrypted multimedia message from a transcoding proxy that had received an encrypted multimedia message from another device and then requested and received a message that enabled the transcoding proxy to decrypt the encrypted multimedia message, transcode the decrypted multimedia message and generate the re-encrypted transcoded multimedia message that was sent to the device.

50. The device of claim 49, wherein said message is a transcoding rights object (TRO) message that includes a content encryption key (CEK) and permission for transcoding the multimedia message.
